(19) United States
(12) Patent Application Publication
(10) Pub. No.: US 2014/0197675 A1
(43) Pub. Date: Jul. 17, 2014

(54) Self-lubricating and Cooling Metal Face Seal

(71) Applicants: Todd R. Morman, Pottsboro, TX (US); Stephen Tressel, Pembroke, MA (US); Matthew Douville, Worcester, MA (US)

(72) Inventors: Todd R. Morman, Pottsboro, TX (US); Stephen Tressel, Pembroke, MA (US); Matthew Douville, Worcester, MA (US)

(73) Assignee: Siemens Industry, Inc., Alpharetta, GA (US)

(21) Appl. No.: 13/739,048

(22) Filed: Jan. 11, 2013

(51) Int. Cl. F16J 15/34

(52) U.S. Cl. CPC F16J 15/3404
USPC 301/105.1; 277/399

(57) ABSTRACT

A self-lubricating and cooling metal face seal includes a rotating seal half and a stationary seal half. The seal halves include complimentary textures configured to move and retain lubricant. The rotating seal half has a texture comprising an alternating series of plows and troughs circumferentially spaced around an inner diameter of the rotating seal half. The stationary seal half has a texture comprising collection and distribution grooves circumferentially spaced around an inner diameter of the stationary seal half. A drive axle includes a spindle and a wheel hub rotatably connected to the spindle. A metal face seal is located at an interface between the spindle and the wheel hub.

### BACKGROUND

The present disclosure relates generally to lubrication systems, and more particularly to lubrication seals.

Many mechanical devices require lubrication systems to promote longevity of moving parts by reducing friction between parts moving relative to one another. Lubrication systems typically require seals to prevent or minimize leakage of lubricant and prevent intrusion of foreign material such as abrasives.

Mechanical drives on off-highway equipment such as dump trucks, backhoes, front end loaders, etc. are subject to abrasive media such as sand, mud, dust, etc. A metal face seal is typically used to dynamically seal mechanical drives whose undercarriages are exposed to adverse environmental conditions which occur during off-highway vehicle operations.

Some mechanical drives have high peripheral seal speeds due to the large diameter of the seals which can be greater than 500 mm. When the size of the equipment becomes very large, the peripheral speed of the rotating seal half increases and heat generation due to the high peripheral speed becomes a threat to the life of a polymer component of the seal. In addition, in certain situations, the lubricant level of the mechanical drive is lower than desired for optimal seal performance due to various design constraints. The high peripheral seal speeds and lower than desired lubricant level typically result in the generation of heat from friction as the seal moves relative to a sealing surface. The heat generated can be sufficiently high to shorten the life of the seal.

### SUMMARY

In one embodiment, a seal includes a rotating seal half and a stationary seal half. The rotating seal half and the stationary seal half have complimentary textures configured to move and retain lubricant. In one embodiment, a texture of the rotating seal half has an alternating series of plows and troughs circumferentially spaced around an inner diameter of the seal half. Each plow can comprise a raised triangle having a rounded tip pointing in a direction of the stationary seal half. Each trough can comprise a triangular depression having a rounded tip which points in a direction away from the stationary seal half. In one embodiment, the stationary seal half comprises X-shaped lubrication collection and distribution grooves circumferentially spaced around an inner diameter of the seal half. Each groove of the lubrication collection and distribution grooves can be in fluid communication with an adjacent groove.

In one embodiment, a drive axle includes a spindle and a wheel hub rotatably connected to the spindle. A metal faced seal can be located at an interface between the spindle and the wheel hub. The metal face seal can comprise a rotating half and a stationary seal half.

These and other advantages of the invention will be apparent to those of ordinary skill in the art by reference to the following detailed description and the accompanying drawings.

### BRIEF DESCRIPTION OF THE DRAWINGS

FIG. 1 shows one half of a drive axle for an off-highway vehicle;

FIG. 2 shows a self-cooling metal face seal according to one embodiment;

FIG. 3 shows a cutaway of the drive axle shown in FIG. 1;

FIG. 4 shows a portion of an inner diameter self-cooling metal face seal according to one embodiment;

FIG. 5 depicts lubricant flow with respect to a rotating seal half according to one embodiment; and

FIG. 6 depicts lubricant flow with respect to a stationary seal half according to one embodiment.

### DETAILED DESCRIPTION

In one embodiment, a seal comprises two seal halves having complimentary textures for distributing lubricant from a lubricant reservoir in a lubrication sump to seal faces of the two halves in order to lubricate and cool the seal. Complimentary textures are textures which work together to move lubricant from one are or location to another area or location. A rotating seal half comprises a texture for lifting lubricant from the lubricant reservoir and the stationary seal half comprises a texture for receiving lubricant from the rotating seal half.

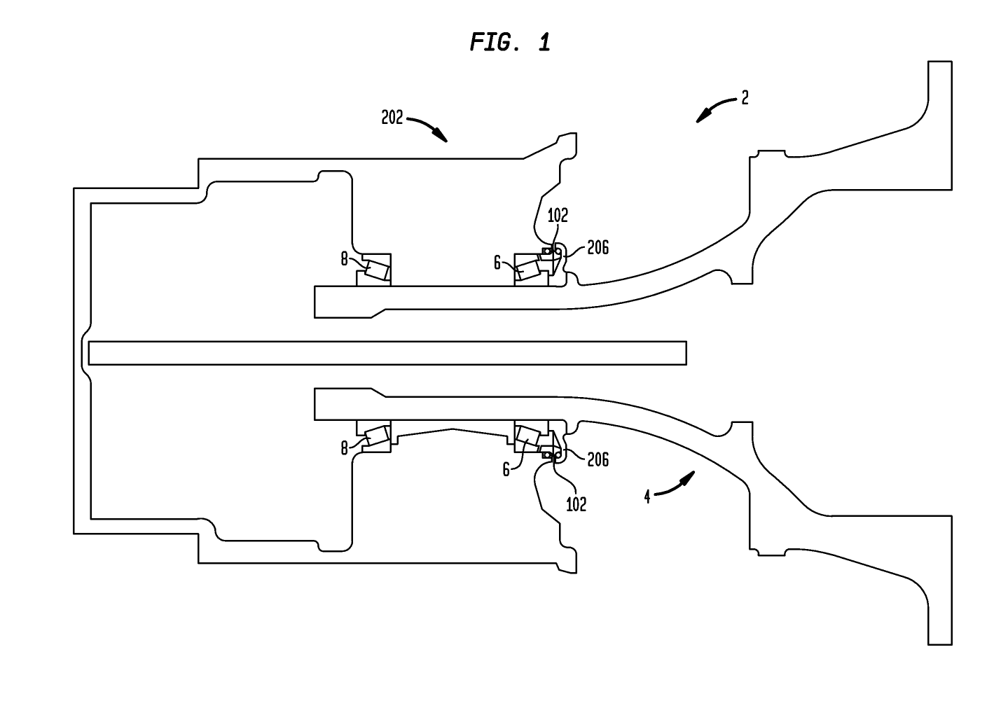

In one embodiment, such a seal is used to prevent escape of lubricant from and intrusion of foreign material into mechanical drives of off-highway equipment. FIG. 1 depicts one half of a drive axle 2 for an off-highway vehicle. Spindle 4 supports seal retainer 206 and tapered roller bearings 6,8. Tapered roller bearings 6,8 rotatably connect rotating wheel hub 202 to spindle 4. In operation, a rim and wheel assembly (not shown) are mounted to wheel hub 202 which rotates around a longitudinal axis of spindle 4 via roller bearings 6,8. Self-cooling metal face seal 102 is located at the interface between spindle 4 and wheel hub 202.

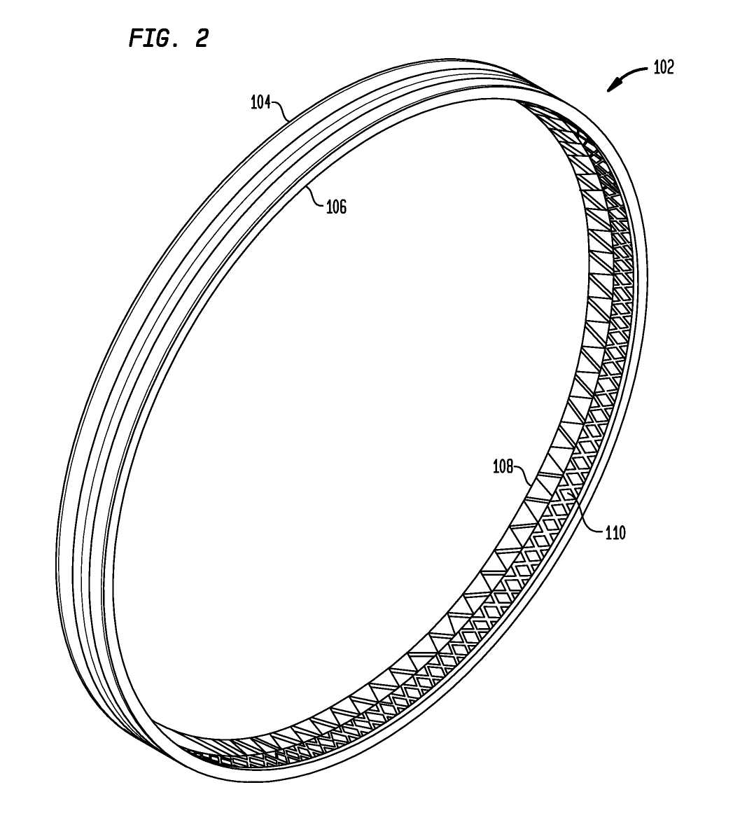

FIG. 2 shows a self-cooling metal face seal 102 comprising a rotating seal half 104 and stationary seal half 106. Rotating seal half 104 and stationary seal half 106 are substantially ring shaped having an inner diameter based on a required clearance around objects which rotating seal half 104 and stationary seal half 106 surround. In one embodiment, seal halves 104,106 encircle a spindle shaft which is stationary. In other embodiments, spindle shaft can be rotatable. Rotating seal half 104 and stationary seal half 106 each have a width sufficient to support complimentary textures 108, 110 for moving and retaining lubricant respectively. The complimentary textures are described in further detail below. Rotating seal half 104 and stationary seal half 106 have outer diameters sized to be frictionally retained in a corresponding substantially circular opening via a retaining device such as an O-ring.

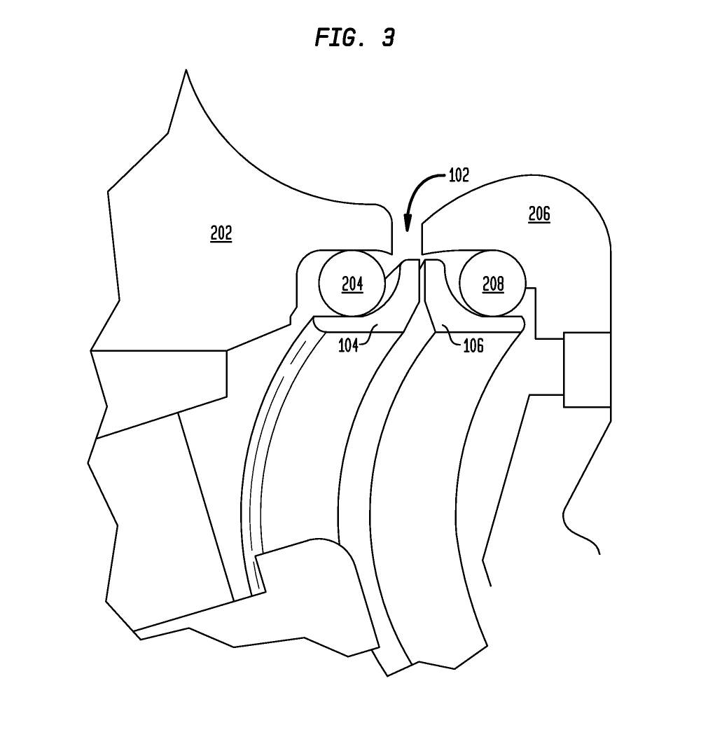

FIG. 3 depicts a cutaway of drive axle 2 shown in FIG. 1 which utilizes self-cooling metal face seal 102. Rotating seal half 104 is shown having a substantially L-shaped cross section and is frictionally held in a substantially circular opening of rotating wheel hub 202 via O-ring 204. Stationary seal half 106 has an L-shaped cross section which is a mirror image of the L-shaped cross section of rotating seal half 104. Stationary seal half 106 is frictionally held in seal retainer 206 via O-ring 208. In operation, stationary seal half 106, O-ring 208, and seal retainer 206 remain stationary while rotating seal half 104, O-ring 204 and rotating wheel hub 202 rotate around a longitudinal axis of rotating seal half 104. In one embodiment, in addition to retaining seal halves 104, 106 in place, O-rings 204, 208 also urge seal halves 104,106 into contact with one another as shown in FIG. 3. More specifically, O-rings 204,208 urge the short lengths of the L-shaped cross sections of each of seal halves 104, 106 toward one another. It should be noted that the surfaces of seal halves 104, 106 urged into contact with one another are referred to as the faces of seal halves 104,106. In one embodiment, the seal faces are made from a ferrous alloy using various methods such as casting or forging. The material selected for the seal faces, in one embodiment, has certain inherent properties such as a low wear rate and a low coefficient of friction. O-rings 204, 208, in one embodiment, are made from a compressible polymer. In one embodiment, BUNA is the polymer used. In other embodiments, other polymers, such as silicone, Viton, or other engineered polymers are used. In one embodiment, the material of O-rings 204, 208 is selected based on one or more of stable compressibility (spring constant), chemical resistance, and thermal breakdown resistance.

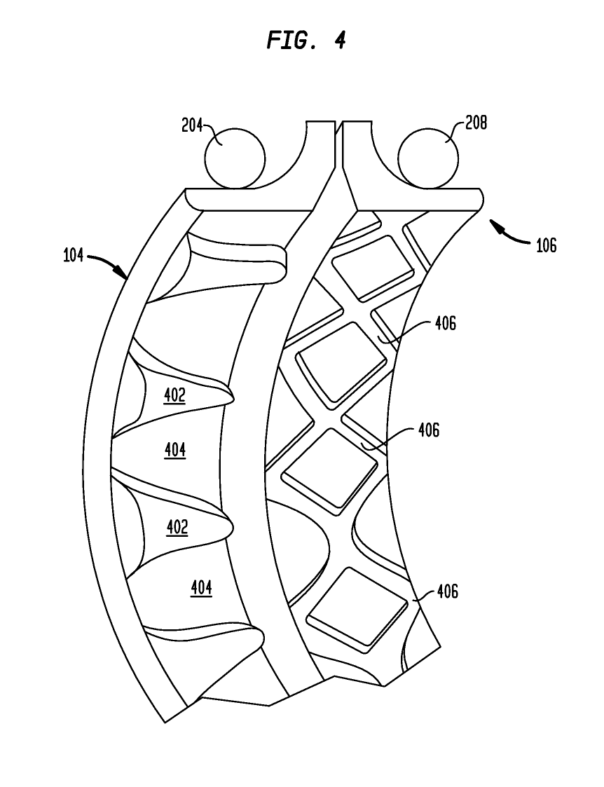

FIG. 4 depicts a portion of the inner diameter self-cooling metal face seal 102 in which the complimentary textures of the seal halves are detailed.

Rotating seal half 104 comprises a series of alternating plows 402 and troughs 404 circumferentially spaced around its inner diameter. In one embodiment, each plow 402 comprises a raised triangle having a rounded tip which points in the direction of stationary seal half 106. Each trough 404 comprises a triangular depression located between each plow 402, the triangular depression having a rounded tip which points away from stationary seal half 106.

Stationary seal half 106 comprises a series of X-shaped lubrication collection and distribution grooves 406 according to one embodiment. The tips of each X-shaped groove 406 are in fluid communication with the adjacent X-shaped grooves 406 (i.e., the tips of each X-shaped groove 406 allow fluid to flow to the adjacent X-shaped grooves 406).

In operation, rotating seal half 104 moves relative to stationary seal half 106. Rotating seal half 104 rotates through a lubricant reservoir which is generally a sump which holds lubricant via gravitational forces. Rotating seal half 104 rotating through the lubricant reservoir causes lubricant to flow into troughs 404 and be pushed along by plows 402. Rotation of rotating seal half 104 and the angled flank of each plow 402 urge lubricant from the troughs 404 toward stationary seal half 106. As rotating seal half 104 rotates, lubricant is moved from the troughs 404 or the rotating seal half 104 into X-shaped lubrication collection and distribution grooves 406 of the stationary seal half 106. Movement of lubricant from the lubrication reservoir to rotating seal half 104 and stationary seal half 106 aids in lubrication and cooling of the seal halves thereby lowering the operating temperature of the seal halves and promoting the lifetime of the seal halves. Lubricant drains under the force of gravity from stationary seal half 104 and returns to the lubricant reservoir. The lubrication reservoir must contain a level of lubricant sufficient to continually supply lubricant to rotating seal half 104 in order to lubricant and cool seal 102. Rotating seal half 104 rotates and lifts lubricant via the coupling of rotating seal half 104 and wheel hub 202. Rotation of wheel hub 202 and rotating seal half 104 causes lubricant to be lifted and simultaneously projected axially toward stationary seal half 106. Collection and distribution grooves 406 of stationary seal half 106 receive and distribute lubricant across the exposed surface area of stationary seal half 106. Gravity forces the lubricant heat by contact with seal 102 back to the lubrication reservoir.

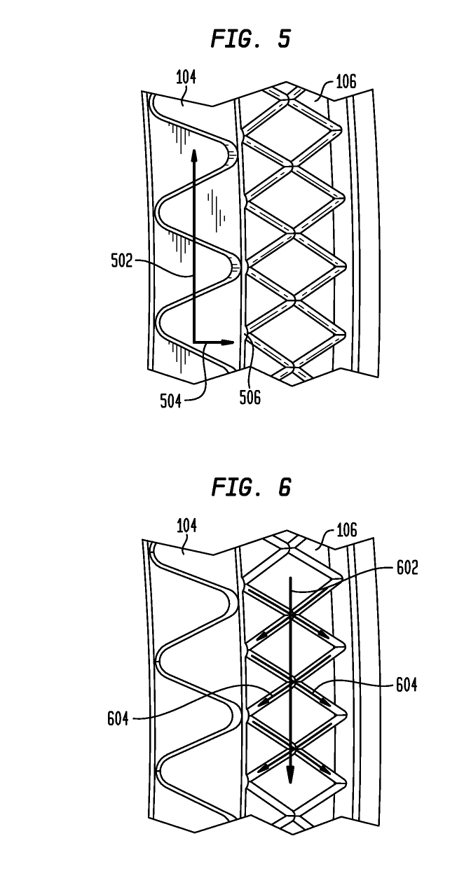

FIG. 5 depicts lubricant flow over the surface of rotating seal half 104. As rotating seal half 106 is rotated through a lubricant reservoir, lubricant is urged by the texture of the seal in the direction of arrow 502. Lubricant is also urged in the direction of arrow 504 toward stationary seal half 106. Lubricant enters collection and lubrication grooves of stationary seal half 106 via inlets 506.

FIG. 6 depicts lubricant flow through collection and lubrication grooves of stationary seal half 106. Lubricant flows downward under the force of gravity in the direction of arrow 602. Arrows 604 show the flow of lubricant within collection and distribution grooves of stationary seal 106.

It should be noted that in conventional applications in which seal 102 is used, acceptable operation of the seal occurs when a standing lubricant level (i.e., the level of lubricant when drive axle is stationary and the majority of lubricant has returned to the lubricant reservoir) is more than one-third of the outer diameter of the seal. However, in some seal applications a standing lubricant level is significantly lower since higher standing lubricant levels are not practical. It is in these applications, where the standing lubricant level is lower then desired to properly cool a seal, that the inventive concept of the present disclosure can produce significant benefits.

The degree of optimization for an application of seal 102 can be determined by employing thermal sensors to stationary seal half 106 and measuring the absolute operating temperature under various operating conditions, and also measuring the differential between stationary seal half 106 at various circumferential locations.

Since plows 402 are substantially symmetrical, rotating seal half 104 can operate to move lubricant toward stationary seal half 106 regardless of the direction of rotation of rotating seal half. In some embodiments, plow 402 can be differently shaped to provide different lubricant movement and distribution properties.

It should be noted that although stationary seal half 106 is described having X-shaped lubrication collection and distribution grooves 406, other configurations of lubrication and distribution grooves can be used. For example, in one embodiment, lubrication collection and distribution grooves can have a more flowing shape, such as a serpentine. The number, shape, depth, depth angles, radii, and other features which define the lubrication collection and distribution grooves can be optimized to provide a maximum amount of lubricating and cooling, via maximization of the volume of fluid retained on the seal and the surface area of a seal covered with lubricant. Groove geometry may also take into account the volume of lubricant received from a rotating seal half, such as inlet grooves. In one embodiment, optimization of a texture of a seal is derived from the particular application. For example, seal texture can be formed based on gearbox rotation direction, the peripheral speed of a seal, and the viscosity of the lubricant at the operating temperature of the drive axle.

In one embodiment, rotating seal half 104 and stationary seal half 106 are cast from a suitable metal such as iron. The complimentary textures of rotating seal half and stationary seal half 106 can be cast or machined after casting of the seal halves. In one embodiment, rotating seal half 104 and stationary seal half 106 are machined from stock. In an alternative embodiment, rotating seal half 104 and stationary seal half 106 are cast without textures which are added via a joining process. For example, each of the halves can have textures added by brazing a non-ferrous high thermal conductivity to each half.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A metal face seal comprising:
a rotating seal half;
a stationary seal half;
wherein the rotating seal half and the stationary seal half have complimentary textures, the complimentary textures configured to move and retain lubricant.

2. The seal of claim 1 wherein a texture of the rotating seal half is configured to lift lubricant from a lubricant reservoir as the rotating seal half is moved through the lubricant reservoir.

3. The seal of claim 1 wherein a texture of the rotating seal half comprises an alternating series of plows and troughs circumferentially spaced around an inner diameter of the rotating seal half.

4. The seal of claim 3 wherein the troughs are configured to lift lubricant from a lubricant reservoir and the plows are configured to move lubricant from the troughs to the stationary seal half.

5. The seal of claim 1 wherein a texture of the stationary seal half comprises lubrication collection and distribution grooves circumferentially spaced around an inner diameter of the stationary seal half.

6. The seal of claim 5 wherein the texture of the stationary seal half is configured to receive lubricant from the rotating seal half.

7. The seal of claim 3 wherein each plow of the alternating series of plows and troughs comprises a raised triangle having a rounded tip which points in a direction of the stationary seal half.

8. The seal of claim 3 wherein each trough of the alternating series of plows and troughs comprises a triangular depression having a rounded tip which points in a direction away from the stationary seal half.

9. The seal of claim 5 wherein the collection and lubrication grooves are X-shaped and each groove of the lubrication collection and distribution grooves is in fluid communication with an adjacent groove.

10. The seal of claim 1 wherein a texture of the rotating seal half is configured to lift lubricant from a lubricant reservoir as the rotating seal half is moved through the lubricant reservoir and a texture of the stationary seal half is configured to receive lubricant from the rotating seal half.

11. A drive axle comprising:
a spindle;
a wheel hub rotatably connected to the spindle;
a lubricant reservoir; and
a metal face seal located at an interface between the spindle and the wheel hub, the metal face seal comprising:
a rotating seal half; and
a stationary seal half;
wherein the rotating seal half and the stationary seal half have complimentary textures, the complimentary textures configured to move and retain lubricant from the lubricant reservoir.

12. The drive axle of claim 11 wherein a texture of the rotating seal half is configured to lift lubricant from the lubricant reservoir as the rotating seal half is moved through the lubricant reservoir.

13. The drive axle of claim 11 wherein a texture of the rotating seal half comprises an alternating series of plows and troughs circumferentially spaced around an inner diameter of the rotating seal half.

14. The drive axle of claim 13 wherein the troughs are configured to lift lubricant from the lubricant reservoir and the plows are configured to move lubricant from the troughs to the stationary seal half.

15. The drive axle of claim 11 wherein a texture of the stationary seal half comprises lubrication collection and distribution grooves circumferentially spaced around an inner diameter of the stationary seal half.

16. The drive axle of claim 15 wherein the texture of the stationary seal half is configured to receive lubricant from the rotating seal half.

17. The drive axle of claim 13 wherein each plow of the alternating series of plows and troughs comprises a raised triangle having a rounded tip which points in a direction of the stationary seal half.

18. The drive axle of claim 13 wherein each trough of the alternating series of plows and troughs comprises a triangular depression having a rounded tip which points in a direction away from the stationary seal half.

19. The drive axle of claim 15 wherein the collection and lubrication grooves are X-shaped and each groove of the lubrication collection and distribution grooves is in fluid communication with an adjacent groove.

20. The drive axle of claim 11 wherein a texture of the rotating seal half is configured to lift lubricant from a lubricant reservoir as the rotating seal half is moved through the lubricant reservoir and a texture of the stationary seal half is configured to receive lubricant from the rotating seal half.
